(19) United States
(12) Patent Application Publication
(10) Pub. No.: US 2026/0317134 A1
(43) Pub. Date: Oct. 15, 2026

(54) Method for installing a heavy load in a supporting structure and a system built according to the method

(71) Applicant: DSD HEAVY LIFT AG, Oberageri (CH)

(72) Inventor: Claude Camille Pirson, Alosen (CH)

(73) Assignee: DSD HEAVY LIFT AG, Oberageri (CH)

(21) Appl. No.: 19/478,610

(22) PCT Filed: Apr. 23, 2024
(86) PCT No.: PCT/EP2024/061055

§ 371 Date: Oct. 24, 2025

(30) Foreign Application Priority Data
Apr. 28, 2023 (CH) 00460/23

(51) Int. Cl. B66F 9/02; B66C 13/08; B66C 17/26; E04G 21/16

(52) U.S. Cl. CPC B66F 9/02; B66C 13/08; B66C 17/26; E04G 21/163

(57) ABSTRACT

In a method for installing a heavy load in a supporting structure (15), the at least one heavy load is conveyed upwards in said supporting structure (15) and secured so that it can be fixed in the operating position. The heavy load to be moved is, in particular, a reactor (20) for metal extraction in an at least approximately operationally ready state. The heavy load is moved horizontally, by a means of transportation means (11), until partially moved into the supporting structure (15). It is then swivelled upwards by a lifting system (25) mounted in the supporting structure (15) and moved upwards in the supporting structure (15) to its operating position and secured. The heavy load is tilitably mounted on the transportation means (11) so that it can be swivelled up and is lifted off the transportation means (11) by the lifting system (25). In this way, despite the enormously high weight load, this heavy load can be guided to the supporting structure when assembled, swivelled into same and pulled up into the operating position.

The invention concerns a method for installing a heavy load in a supporting structure, in which the at least one heavy load is conveyed upwards in said supporting structure and secured, so that it can be fixed in the operating position, as well as a method for installing a supporting structure and a system according to the generic terms of Claim 1, Claim 10 and Claim 14.

In order to sustainably minimize environmentally harmful emissions in metal production, as well as in the iron and steel industry, efforts are being made to implement new technologies that can practically eliminate CO₂ emissions. For example, in the extraction of iron from iron ore, new production processes are being sought, in which the direct reduction of iron ore can preferably be carried out using renewable energies, instead of conventional blast furnaces that use coking coal as an energy source. Natural gas or, even better, hydrogen is advantageous for this purpose, as it enables the reduction process to be carried out largely without CO₂ emissions.

For this purpose, new systems are being built which, similar to blast furnaces, each have a complex reactor vessel as a heavy load in a supporting structure or the like. The system for operation with the complex reactor vessel is designed in such a way that the supply of iron ore and other components, as well as energy, into the reactor can be optimally ensured in logistical terms and that the cooling of the reactor walls is also ensured.

Such complex reactor vessels can each have a tare weight of over 1000 tonnes and are therefore usually assembled at the operating site in the supporting structure from a large number of individual parts and simultaneously fastened to this supporting structure. This procedure is complex and involves correspondingly high costs due to the use of large cranes for the construction of the supporting structure as well as the assembly and installation of the reactor within it. In addition, the reactor must be designed in such a way that it can be assembled into the supporting structure or the like, taking into account any circumstances that may mean that it cannot be designed in an optimum manner.

The invention has for its object to create a method for installing a heavy load in a supporting structure, by means of which such installation in the operational state in the supporting structure can be carried out more safely, more time-sparingly and therefore more cost-effectively and the heavy load can be designed in such a way that restrictions such as those required for assembly in the supporting structure do not have to be taken into account.

This object is achieved according to the invention by the features of Claim 1, Claim 10 and Claim 15.

According to the inventive method, the heavy load to be conveyed is, in particular, a reactor for metal extraction in an at least approximately operationally ready state. The heavy load is moved horizontally, by a transportation means, until partially moved into the supporting structure. It is then swivelled upwards by a lifting system, preferably a strand jack system, mounted in the supporting structure and moved upwards in the supporting structure to its operating position and secured. The heavy load is tiltably mounted on the transportation means so that it can be swivelled upwards and is lifted off the transportation means by the lifting system.

In this way, according to the inventive method, despite the enormously high weight load, this heavy load, which is in particular a reactor for metal extraction, can be guided to the supporting structure when assembled, swivelled into said supporting structure in a safe manner, and hoisted into the operational position.

Preferably, a known SPMT (Self-Propelled Modular Transporter) is used as the transportation means, which consists of a platform with such a large number of axles and wheels that the load per wheel corresponds to its possible weight load.

The lifting system mounted in the supporting structure preferably uses a strand jack system, which is also known per se. Such strand jacks are suitable for hoisting or carrying heavy loads and by using several of them pulling at the same time, this heavy load can be hoisted into the operating position.

Conveniently, the heavy load, which is provided with a removable reinforcing device in the front area, is moved by the transportation means partially into the interior of the supporting structure and at least one longitudinal element of the lifting system, preferably designed as a strand, is connected to a connection point on the reinforcing device of the heavy load. This extremely simple coupling allows this heavy load to be connected to the lifting system and swivelled upwards without any complicated manipulation.

On the underside of the heavy load in its horizontal transportation position, a tilting mechanism is detachably fastened and articulated to it. This tilting mechanism is swivelled upwards together with the heavy load and, before the heavy load reaches its upright position, hits a stop on the underside and causes the swivelling of the heavy load to stop. With this tilting mechanism it is ensured that the reactor, with its torpedo-like outer shape with different diameters, can rest on top of the platform of the transportation means in the tilting mechanism and can be mounted horizontally on this tilting mechanism or on the transportation means.

The transportation means is very advantageously controlled in such a way that when the heavy load is swivelled upwards, it travels partly into the interior of the supporting structure at a driving speed corresponding to that of the swivel movement. This ensures that the connection point on the container and at least one longitudinal element of the lifting system acting on it move approximately vertically upwards in the supporting structure, thus ensuring that the heavy load is swivelled upwards in a controlled and safe manner.

For lifting the heavy load after it has been lifted from the transportation means in the upright position, the invention provides that additional longitudinal elements of the lifting system are coupled to a connection point on the reinforcing device, preferably on the opposite side to the already connected longitudinal element(s) of the heavy load, in order to apply the necessary tensile force to the heavy load.

According to the invention, the supporting structure is built to a certain intermediate height and then this lifting system is mounted on the supporting structure. Consequently, the heavy load can then be conveyed and secured at this intermediate height using the lifting system. At the same time as the heavy load is being installed, the crane system, which has already installed the supporting structure up to said intermediate height and the lifting system on top of it, can be used to install additional loads up to their full height. This results in considerable time saving during the entire installation process, while at the same time the usage time of the crane system can be reduced to a minimum.

The invention and further advantages thereof are explained in more detail below using design examples with reference to the drawing. Drawings:

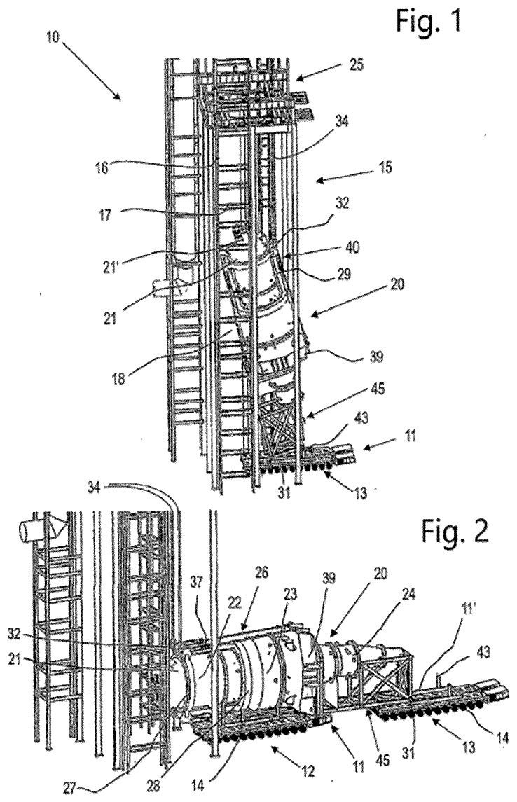

FIG. 1 is a perspective side view of the lower part of the system according to the invention, with a heavy load designed as a reactor in a supporting structure as well as a transportation means carrying the heavy load and, above the heavy load, the lifting system in the supporting structure;

FIG. 2 is a perspective side view of the system according to FIG. 1 in the horizontal transportation position of the reactor on the transportation means shown, in which this reactor is inserted with its front head part into the indicated supporting structure;

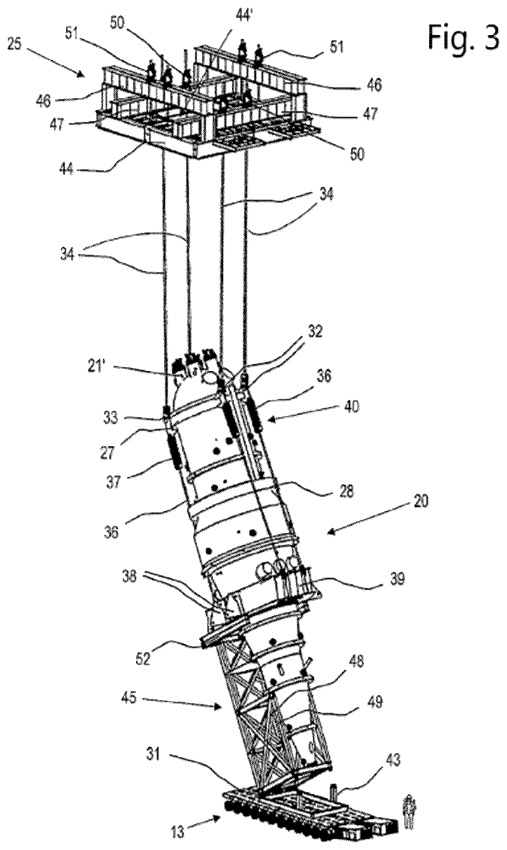

FIG. 3 is a perspective side view of the reactor and the lifting system according to FIG. 1, wherein the reactor is shown in the raised position on the transportation means without the supporting structure; and

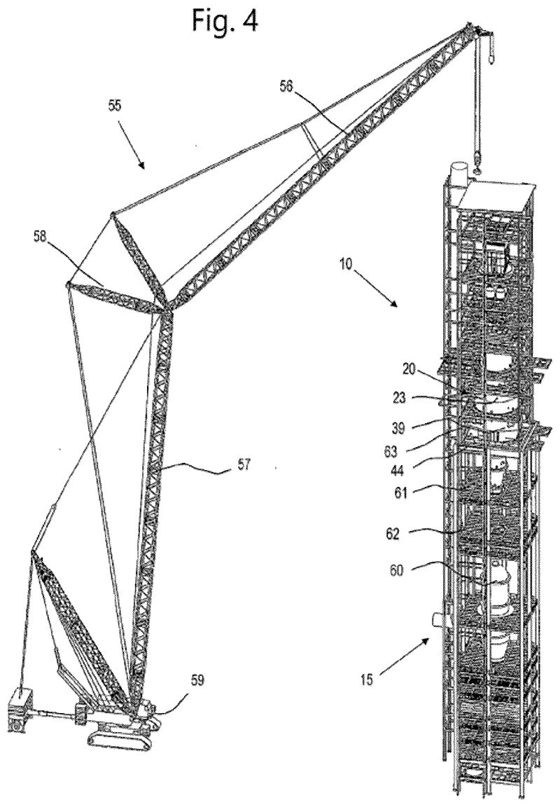

FIG. 4 is a perspective view of the finished system according to FIG. 1 with the reactor installed in the supporting structure and a cooler tank as well as a crane system next to the system.

FIG. 1 to FIG. 4 show a schematically illustrated system 10 with a supporting structure 15 and a heavy load to be installed in the latter as a reactor 20. This supporting structure 15 consists of a lattice-shaped structure as a basic framework with longitudinal and transverse elements 16, 17, whereby it is designed on the inside with a cavity 18 and, due to the required height, as a tower. As mentioned, it is only presented in principle. In any case, it must be provided with statics proving that it can permanently absorb the enormous load forces of the heavy load to be in-stalled. This supporting structure can be designed in different ways depending on the circumstances and requirements and can be placed free-standing in a work area or be part of a building with a number of levels or the like.

According to the inventive method, the heavy load to be conveyed is, in particular, a reactor 20 for metal extraction in an at least approximately operationally ready state. This reactor 20 as a heavy load is moved by a transportation means 11, preferably by an SPMT (Self-Propelled Modular Transporter), in a horizontal direction up to or partially into the cavity 18 of the supporting structure 15 and it is swivelled upwards by a lifting system 25 mounted in the supporting structure 15, preferably a strand jack system, and hoisted in the supporting structure 15 to its operating position and fastened there. So that it can be swivelled upwards into its approximately upright position, the reactor 20 is tiltably mounted on the underside of the transportation means 11 and is swivelled using an articulated joint 31.

The invention is characterized in that it allows, in particular, such a reactor 20 in an at least approximately operationally ready state, with a tare weight of over 1000 tonnes, to be lifted in a completely new way into the required operating position up to a height of, for example, 80 m. The reactor is in particular one that processes iron ore through direct reduction using renewable energies and extracts iron from it in a multi-stage process, primarily for the metal industry.

The reactor 20, designed as a container with a torpedo-like outer shape, consists of a front stepped cylindrical section 22 with a head part 21 with several upwardly projecting connecting pieces 21′, which are not explained in more detail, as well as a hull 23 with an enlarged diameter, with a support frame 39 and a conical lower part 24 extending approximately to a point.

The cylindrical section 22 has mounted to its outer shell a reinforcing device 26, which is installed either fixedly or advantageously removable. It has two reinforcing elements 27, 28 arranged at a distance from one another, which are fastened in a removable manner as rings on the outer circumference of the reactor 20 and are fastened to one another by at least one connecting bridge 29. On the front reinforcing element 27, two connection points 32, 33 are advantageously provided on opposite sides, spaced apart from one another, which can be connected to the longitudinal elements 34 of the lifting system 25. When swivelling the reactor upwards 20, only the two connection points 32 on its upper side have to be coupled with longitudinal elements 34, while the opposite connection points 33 are connected to such longitudinal elements 34 only after swivelling for hoisting the reactor 20, so that this lifting system 25 is able to lift the reactor 20 up to its final position.

In addition, the reinforcing elements 27, 28 are each assigned an adjustable tensioning device 40 (not explained in more detail) on the outside of the reactor, each consisting of an elongated tensioning element 37 and a traction element 36 coupled thereto, each generating adjustable tensile stress in its longitudinal direction. At each of the four connection points 32, 33, such a clamping element 37 engages with one end, which extends parallel to the axial direction of the reactor and is held at the other end by the annular support frame 39. With these tensioning devices 40, tensile forces can be generated on the front reinforcing element 27 in a coordinated manner in the opposite direction to the lifting force of the longitudinal elements 34 in order to counteract this lifting force on the reinforcing element 27.

This exemplified reactor 20 may, of course, be shaped differently than shown. For example, the hull 23 and the upper cylindrical section 22 with the head part 21 could be assembled first, followed by the lower part 24. Likewise, this reinforcing device 26 can also be equipped, for example, with only one reinforcing element and without these tensioning devices 40. Fewer or more than four such connection points 32, 33 may be provided, depending on the weight of the heavy load.

As can be seen from FIG. 1, the front head part 21 of the reactor 20 with the reinforcing element 27 of the reinforcing device 26 is moved by the transportation means 11 into the interior of the supporting structure 15 and the two longitudinal elements 32 of the lifting system 25, which are preferably designed as strands, are connected in this position to the respective connection point 32 of the reinforcing device 26 and the reactor 20 is swivelled upwards as a heavy load by actuating the lifting system.

The transportation means 11 with an upper platform 11′ is preferably formed by two independently movable transportation units 12, 13, which together convey the heavy load partially to the supporting structure 15, as illustrated in FIG. 2. These transportation units 12, 13 consist of such a large number of axles and wheels that the load per wheel corresponds to the specified weight load, with each axle being individually driven. After connecting the longitudinal elements 32 of the lifting system 25 to the reactor 20 and lifting it off, the front transportation unit 12 is removed, while the rear transportation unit 13, with a tilting mechanism 45 articulated to it, and with it the reactor, moves inside into the cavity 18 of the supporting structure 15 and at the same time the reactor is pivoted upwards in the cavity.

The reactor 20, with its torpedo-like outer shape with different diameters, rests on top of the platform 11′ of the transportation means 11 at several preferably flat points of the tilting mechanism 45 and when approaching can be mounted horizontally on this tilting mechanism and on the transportation means. This box-shaped tilting mechanism 45 is composed of longitudinally and transversely connected supporting elements 48, 49, this articulated joint 31 and a supporting element 52 holding the support frame 39 of the reactor 20 on the underside. This tilting mechanism can be designed differently depending on the external shape of the heavy load and can consist of several modules.

This rear transportation unit 13 of the transportation means 11 is moved into the interior of the supporting structure when the reactor 20 is swivelled upwards, at a controlled driving speed corresponding to the swivelling speed, so that the connection points 32 of the reactor and the longitudinal element 34 of the lifting system 25 engaging therewith move approximately vertically upwards in the supporting structure 15 and the reactor is hoisted upwards with a linear swivel movement and no disturbing vibrations occur in the process.

The reactor 20 is swivelled up to a position, as shown in FIG. 1, in which the tilting mechanism 45 rests with its underside facing the articulated joint 31 with at least one stop 43 on the transportation unit 13. The two longitudinal elements 34 of the lifting system 25 on the other side are articulated to the connection points 33 of the reinforcing device 26 in addition to the already connected longitudinal elements 34. The reactor is swivelled into this inclined position rather than the upright position, to prevent it from tipping over to the other side. In principle, however, it could be swivelled up to an approximately upright position and then the additional longitudinal elements 34 could be attached.

This articulated joint 31 on the transportation means, as well as the tilting mechanism 45, are then detached and dismantled from the reactor so that it can be hoisted by the longitudinal elements 34 with equal amounts of force. Further longitudinal elements, not shown, are provided which are hinged to connection points 38 on the support frame 39 below the hull 23 so that the reactor 20 can be guided through the lifting system 25 to its final position and fastened in the supporting structure.

For this purpose, the lifting system 25 mounted at a certain height in the supporting structure 15 is provided on the inside with a cavity 44′ through which the reactor 20 can be lifted as a heavy load to the operating position and fixed therein, as can be seen in FIG. 4 for the fully constructed system 10. The reactor 20 is hoisted over a partial height range through the cavity 44′ in the lifting system 25 into the operating position by means of the longitudinal elements 34 of the lifting system 25, which are to be connected in the central region of the reactor 20.

FIG. 3 shows the lifting system 25 arranged in the supporting structure 15, in which a strand jack system is preferably used. This lifting system 25 consists of a base frame 44 carried on the supporting structure 15, of solid cross beams 46, 47, standing thereon in pairs, and of several lifting units 50, 51, in which these longitudinal elements 34 are held adjustably in their longitudinal direction. The one lifting unit 50 and the two cross beams 46 or the other lifting unit 51 and the two cross beams 47 are positioned on the base frame 44 in such a way that the longitudinal elements 34 extending through them and hinged at the connection points 32, 33 and 38 of the reactor 20 are aligned approximately vertically in order to avoid bending moments in these longitudinal elements, which are usually manufactured as strands.

Essentially, each of these lifting units 50, which are known per se and not shown in detail, consists of a hydraulic or pneumatic piston/cylinder unit which is fixed on one of the cross beams 46, 47 and has a central through-opening on the inside for receiving one or more longitudinal elements 34. The cylinder is provided with an annular chamber in which the sleeve-shaped piston is guided in the axial direction. At the upper end of the piston and at the lower end of the cylinder, respectively, a clamping device with radially adjustable clamps is provided for holding the longitudinal element(s) 34. When the piston is retracted, its clamps hold the longitudinal element 34 and a medium is forced into a chamber in the cylinder by a pump, so that the piston and with it the longitudinal element are moved upwards. When the piston is extended, the open clamps on the cylinder are closed and those on the piston are opened and the piston is then retracted again. This process is repeated until the heavy load to be lifted has reached its final position. When lifting the heavy load, these strands are moved upwards through and beyond the lifting units 50 and they can be accommodated in straight or rounded guides above the lifting system 25, which is not shown in detail. The control of the multiple piston/cylinder units is coordinated synchronously, which can be achieved through pressure equalisation in order to achieve even load distribution.

It is clear that, conversely, lowering the heavy load with these lifting units 50, which is not explained in more detail, is just as possible. Accordingly, the individual steps for lowering would have to be carried out in reverse order.

The inventive method also extends to the installation of the supporting structure 15 for receiving the heavy load, whereby the supporting structure 15 consists of these stackable longitudinal and transverse elements 16, 17 and/or other support elements, which are constructed by at least one known crane system 55 with several lattice masts 56, 57, 58 on a vehicle 59 as shown in FIG. 4. Very advantageously, the supporting structure 15 is built to a certain intermediate height and then the lifting system 25, of which this base frame 44 can be seen, is mounted on the supporting structure 15 which is built approximately halfway. The reactor is then conveyed as a heavy load by the lifting system 25 to this intermediate height and secured. Practically at the same time, the crane system 55 installs the supporting structure 15 up to its full height, the heavy load to be conveyed being, in particular, this reactor 20 for metal extraction in an at least approximately operationally ready state.

This installation of the supporting structure 15 up to its full height can also be carried out in the manner disclosed in Swiss Patent Application No. CH000608/2023, instead of with the crane system 55 shown, in which the supporting structure could also be fully installed at the top at the same time as the heavy load is being mounted. At least one crane is hoisted from the ground level to the top of the supporting structure 15 and moved onto a flat support for its operation. However, the crane could also have already been installed at this intermediate height and the lower part of the supporting structure 15 could have been constructed with it beforehand. By means of the crane and a lifting system, preferably with several strand jacks, the supporting structure can be constructed in stages by mounting the longitudinal and transverse elements 16, 17 and a lifting system on top of the crane. The assembled lifting system, connected to the support by strands, can then raise the crane one step at a time and build the next level of the supporting structure by pulling the longitudinal and transverse elements 16, 17 up from the ground to the top of the supporting structure 15.

The reactor 20, which is raised in the supporting structure 15 to the lifting system, is guided through this frame-shaped lifting system and is fastened with support frames 39 attached to its outer shell below the fuselage 23, preferably at this intermediate height in the supporting structure 15. The transportation means 11 is moved away after the heavy load has been lifted and can be used to feed further heavy loads into the supporting structure.

While the supporting structure 15 is completed by the crane system 55 up to its total height above the installed heavy load, the lifting system 25 can simultaneously lift and install additional components, such as at least one cooler tank 60, support elements 62, platforms 61, etc., as additional heavy loads in the lower area or below the reactor. Once the reactor is mounted in the supporting structure 15, the same transportation means for delivering and the same longitudinal elements 34 of the lifting system 25 as for lifting the reactor can also be used, with those allocated to the hoisting units 51 on the cross beams 46 being advantageous, because these extend outside the outer shell of the reactor.

By simultaneously mounting it on the lower and upper sections of the supporting structure 15, the first platform in the upper construction section is used as a protective platform 63. This will be reinforced with additional safeguards to protect the personnel working underneath. The lifting system 25 with the cross beams 46, 47, which is temporarily mounted at this specific height in the supporting structure 15, is preferably dismantled again after the complete installation of the heavy load and other components. The supporting structure and the area surrounding it are designed in such a way that this lifting system 25 with the cross beams 46, 47 can be reinstalled in the supporting structure, in particular for dismantling the heavy load and the components. In principle, however, it could also remain in the supporting structure, especially if components need to be replaced or changed from time to time.

The invention is sufficiently demonstrated by the design examples explained above. But of course, it could be explained by additional variants.

As a variant, the lifting system could be equipped with a different number of lifting units 50, 51 and longitudinal elements 34 than those shown and the cross beams 46, 47 could be arranged differently than shown. Likewise, the supporting structure could, for example, be arranged in a building and be primarily made up of supporting pillars or similar.

Lifting systems could include hoists, pulleys, climbing cranes and/or similar.

Instead of an SPMT, another feed system, such as a vehicle sliding on plastic or travelling on rails or the like, could be used as the transportation means 11.

1. Method for installing a heavy load in a supporting structure, in which the at least one heavy load is conveyed upwards in this supporting structure (15) and fastened so that this heavy load is fixed, in particular, in the operating position, characterized in that the heavy load to be conveyed is, in particular, a reactor (20) for metal extraction in an at least approximately operationally ready state, wherein this heavy load is moved by a transportation means (11), preferably by an SPMT (Self-Propelled Modular Transporter), in a horizontal direction up to or partially into the supporting structure (15), and that this heavy load is swivelled upwards by a lifting system (25), preferably a strand jack system, mounted in the supporting structure (15), and is hoisted in the supporting structure (15) into its operating position and fastened, wherein this heavy load is tiltably mounted on the transportation means (11) for the swivelling upwards and is then lifted off the transportation means (11) by the lifting system (25).

2. Method according to claim 1, characterized in that the heavy load, which is provided with a removable reinforcing device (26) in the front area, is moved by the transportation means (11) partially into the interior of the supporting structure (15) and at least one longitudinal element (34) of the lifting system (25), preferably designed as a strand, is connected to a connection point on the reinforcing device (26) of the heavy load and the latter is swivelled upwards by actuating the lifting system (25).

3. Method according to claim 2, characterized in that the transportation means (11) moves into the interior of the supporting structure (15) at a correspondingly controlled driving speed when the heavy load is swivelled upwards by the lifting system (25), so that the connection point at the reactor (20) and the at least one longitudinal element (34) of the lifting system (25) acting on it move approximately vertically upwards in the supporting structure.

4. Method according to claim 3, characterized in that the heavy load, upon reaching its at least approximately upright orientation, is coupled by at least one additional longitudinal element (34) of the lifting system (25), preferably on the opposite side to the already connected longitudinal element (34) of the heavy load, to a connection point (33) of the reinforcing device (26), and the heavy load is then hoisted by at least both longitudinal elements (34).

5. Method according to claim 4, characterized in that a tilting mechanism (45) which is articulated on the transportation means (11) is detachably fastened to the heavy load in its lower region, and said tilting mechanism is swivelled upwards together with the heavy load and preferably abuts against a stop (43) on the underside before the heavy load reaches the upright position and causes the swivelling of the heavy load to stop.

6. Method according to claim 4, wherein in this upwardly pivoted position, this at least one additional longitudinal element (34) of the lifting system (25) is connected to the reinforcing device (26) and/or to a support frame (39) of the heavy load, and that the heavy load is consequently lifted together by the longitudinal elements (34), with equal lifting force components.

7. Method according to claim 1, wherein the transportation means (11) is moved away after the heavy load held on the longitudinal elements (34) has been lifted off, and at least one support element fed into the supporting structure (15) is attached to a support in the lower region of the heavy load by at least one further longitudinal element (34) of the lifting system (25), and that the heavy load is then lifted up by the longitudinal elements (34) together with equal lifting force components.

8. Method according to claim 1, wherein the lifting system (25) with cross beams (46, 47) is mounted at a certain height in the supporting structure (15) and is dismantled again after the complete installation of the heavy load and further components, such as at least one cooler container (60), platforms (61), support elements (62), etc., wherein the supporting structure (15) and the area surrounding it are designed in such a way that this lifting system (25) with the cross beams (46, 47) can be reinstalled in the supporting structure (15), for dismantling the heavy load and/or the components.

9. Method according to claim 1, wherein the transportation means (11) for the heavy load is formed from two independently movable transport units (12, 13) which together transport the heavy load, wherein the front transport unit (12) is removed after the heavy load has been lifted and the rear transport unit (13) with a tilting mechanism (45) articulated to it and the heavy load moves partly into the interior of the supporting structure (15) and at the same time the heavy load is swivelled upwards.

10. Method for installing a supporting structure for receiving a heavy load, which is installed in the supporting structure according to the method according to claim 1, wherein the supporting structure (15) consists of support elements which can be installed one above the other and is constructed by at least one crane system (55), wherein the crane system (55) constructs the supporting structure (15) to a certain intermediate height and then mounts a lifting system (25), preferably a strand jack system, on the supporting structure (15) and that consequently the heavy load is conveyed and secured at this intermediate height by means of the lifting system (25), and that at the same time the crane system (55) can install the supporting structure (15) up to its total height, wherein the heavy load to be conveyed is in particular a reactor (20) for metal extraction in an at least approximately operationally ready state.

11. Method according to claim 10, characterized in that the heavy load lifted in the supporting structure (15) up to the lifting system (25) is guided through this frame-shaped lifting system (25) and is fastened in the supporting structure (15), preferably at this intermediate height by means of support frames (39) attached to its outer casing, preferably in the lower region.

12. Method according to claim 10, wherein the supporting structure (15) is constructed by the crane system up to its total height above the installed heavy load, while at the same time further components, such as at least one cooler tank (60), platforms (61), and support elements (62), are mounted in the lower region or below the heavy load in this supporting structure.

13. Method according to claim 10, wherein the lifting system (25) is mounted in the supporting structure (15) in such a way that it can be removed from this supporting structure, in particular after the installation of the system (10) has been completed, and can preferably be reinstalled therein if at least one heavy load has to be removed from the supporting structure.

14. System with a supporting structure and at least one heavy load held in it, the system having been built according to the method according to claim 1, the supporting structure (15) being provided with support elements assembled one above the other and the heavy load being mounted therein, characterized in that a lifting system (25), preferably a strand jack system, is fastened in the supporting structure (15), preferably at a certain intermediate height, and likewise the heavy load conveyed by means of the lifting system (25) is preferably fastened at around the intermediate height, the heavy load being designed in particular as a reactor for metal extraction, which is mounted in the supporting structure in an at least approximately operational state.

15. System according to claim 14, characterized in that further components, such as at least one cooler tank (60), platforms (61), support elements (62) or the like are mounted in the lower region or below the heavy load in the supporting structure.

16. Heavy load for a system according to claim 14, wherein the heavy load is designed as a container-shaped reactor (20), for metal extraction, which is provided with cylindrical sections in its outer shell, in which a reinforcing device (26) and/or a support frame (39) is attached in the lower region of the container-shaped reactor.

17. Heavy load according to claim 16, characterized in that the reinforcing device (26) comprises at least two reinforcing elements (27, 28), which are arranged at a distance from one another, and which are fastened in a removable manner to the outer circumference of the reactor and are fastened to one another by at least one connecting bridge (29), wherein at least one connection point (32) for articulating one longitudinal element (34) of the lifting system (25) is provided on the upper reinforcing element (27).

18. Heavy load according to claim 16, further comprising a box-shaped tilting mechanism (45) mounted on the underside of the reactor (20), by means of which the reactor (20) is pivotally mounted on the transportation means (11).
